(19) United States
(12) Patent Application Publication
(10) Pub. No.: US 2003/0085296 A1
(43) Pub. Date: May 8, 2003

(54) Hurricane and tornado control device

(76) Inventor: Andrew Waxmanski, Chipley, FL (US)

Correspondence Address: Richard C. Litman, LITMAN LAW OFFICES, LTD., P.O. Box 15035, Arlington, VA, 22215, US

(21) Appl. No.: 09/985,284

(22) Filed: Nov. 2, 2001

(51) Int. Cl. A01G 15/00

(52) U.S. Cl. 239/2.1; 239/14.1

(57) ABSTRACT

A method is disclosed for affecting the formation and/or direction of a low atmospheric weather system. Audio generators are positioned to project sound waves toward a peripheral area of a weather system. The sound waves are generated at a frequency to affect the formation of the weather system in a manner to disrupt, enhance or direct the formation. The sound waves can also be projected in a manner to cause the system to produce rain.

### BACKGROUND OF THE INVENTION

1. Field of the Invention

The present invention generally relates to a method of weather control. More specifically, the present invention is drawn to a method of employing high decibel sound waves to affect the formation of weather systems.

2. Description of Related Art

The ferocious winds and rains of tornadoes and hurricanes account for the loss of many lives and billions of dollars annually. Names such as “Hugo” and “Andrew” have become legendary when people talk of destruction caused by “Mother Nature”.

In the U.S.A., the U.S. Weather Research Program and the National Oceanic Atmospheric Administration have invested millions of dollars in research to find a system(s) which will predict with accuracy the formation and path of potentially violent weather systems.

Of the two, hurricanes are more predictable as to formation and direction. Hurricanes are born over warm tropical oceans and will most likely develop from lower atmosphere storm clusters which coalesce to form a tropical storm. Under certain conditions, water vapor pushed up from the ocean's surface will fuel the tropical storm, creating the violent rotating winds which define a hurricane. Since warm water is the fuel, hurricanes will last much longer over water than over land.

Although occurring in many parts of the world, data collected by the National Oceanic and Atmospheric Administration (NOAA) indicates that tornadoes appear most frequently in the United States east of the Rocky Mountains during the spring and summer months. In an average year, about eight hundred tornadoes are reported. Tornadoes are formed when a change in wind direction and an increase in wind speed create an invisible, horizontal rotating effect in the lower atmosphere as a more powerful weather system (thunderstorm) develops in the higher atmosphere. Rising air within the thunderstorm causes the lower atmosphere rotating air to tilt from horizontal to vertical and form a violently rotating column of air extending from the thunderstorm to the ground. Tornadoes may last from a few minutes (weak) to over an hour (violent) and have wind speeds which range from about one hundred miles per hour to over two hundred miles per hour.

Ongoing research is also being done to cause weather systems to produce rain where needed. This capability would be of obvious advantage in the farming industry.

There are systems disclosed in prior art for preventing the formation of hurricanes and tornadoes. For example, U.S. Pat. No. 2,903,188 (Hutchinson), U.S. Pat. No. 5,441,200 (Rovella, II), and British Patent 2,186,781A disclose methods of disruption of tornado formations which involve cloud seeding.

U.S. Pat. No. 1,980,171 (Amy), U.S. Pat. No. 2,480,275 (van Straten, et al.) and U.S. Pat. No. 4,848,656 (Magill) disclose the use of sound waves to control water droplet content in clouds.

U.S. Pat. No. 230,067 (Ruggles), U.S. Pat. No. 1,279,823 (Balsillie), and U.S. Pat. No. 2,527,230 (Schaefer et al.) show methods of cloud seeding for the production of rain.

U.S. Pat. No. 3,606,153 (Boucher) shows a method of dispersing fog by employing microwaves.

U.S. Pat. No. 5,411,209 (oilivier) and U.S. Pat. No. 5,445,321 (Oilivier) are concerned with employing shock waves to prevent hail.

British Patent 2,156,647A utilizes explosives to generate a cyclone.

None of the above inventions and patents, taken either singly; or in combination, is seen to disclose a method of employing sound waves to affect the formation of weather systems as will subsequently be described and claimed in the instant invention.

### SUMMARY OF THE INVENTION

The present invention requires the recognition of the low atmosphere weather systems near the earth's surface that have the potential to produce hurricanes, tornadoes or rain. When recognition is realized, mega generators are employed to produce high decibel sound waves, which sound waves are projected toward the clouds and rotating winds which form the low atmosphere systems. In one scenario, the high frequency sound waves will function to disrupt and slow the rotating winds, thereby preventing a hurricane or tornado from forming. In another scenario, the high frequency sound waves will function to enhance the rotation of the winds, thereby causing a hurricane or tornado to form. The inventive concept also incorporates utilization of high decibel sound waves to alter the direction of the low atmosphere systems, thereby determining the path of the potential hurricane or tornado.

Sound waves may also be projected at potentially non-violent weather systems to cause such systems to produce rain.

Accordingly, it is a principal object of the invention to provide a process for affecting the formation of low atmospheric weather systems.

It is another object of the invention to provide a process to alter the direction of weather systems which may produce hurricanes and tornadoes.

It is a further object of the invention to provide a process to disrupt or enhance the formation of hurricanes and tornadoes.

Still another object of the invention is to provide a process to produce rain from low atmospheric weather systems.

It is an object of the invention to provide improved steps and arrangements thereof in a method for the purposes described which are dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, schematic view of sound waves directed toward a system which may form a hurricane or tornado according to the present invention.

FIG. 2 is a schematic top view of sound waves directed toward a system which may form a hurricane or tornado according to the present invention.

FIG. 3 is a schematic view of sound waves directed to steer a hurricane or tornado to the right according to the present invention.

FIG. 4 is a schematic view of sound waves directed to steer a hurricane to the left according to the present invention.

FIG. 5 is a schematic view of sound waves directed to create a hurricane or tornado according to the present invention.

FIG. 6 is a schematic view of sound waves directed at a system to generate rain.

Similar reference characters denote corresponding features consistently throughout the attached drawings.

### DETAILED DESCRIPTION OF THE PREFERRED EMBODIMENTS

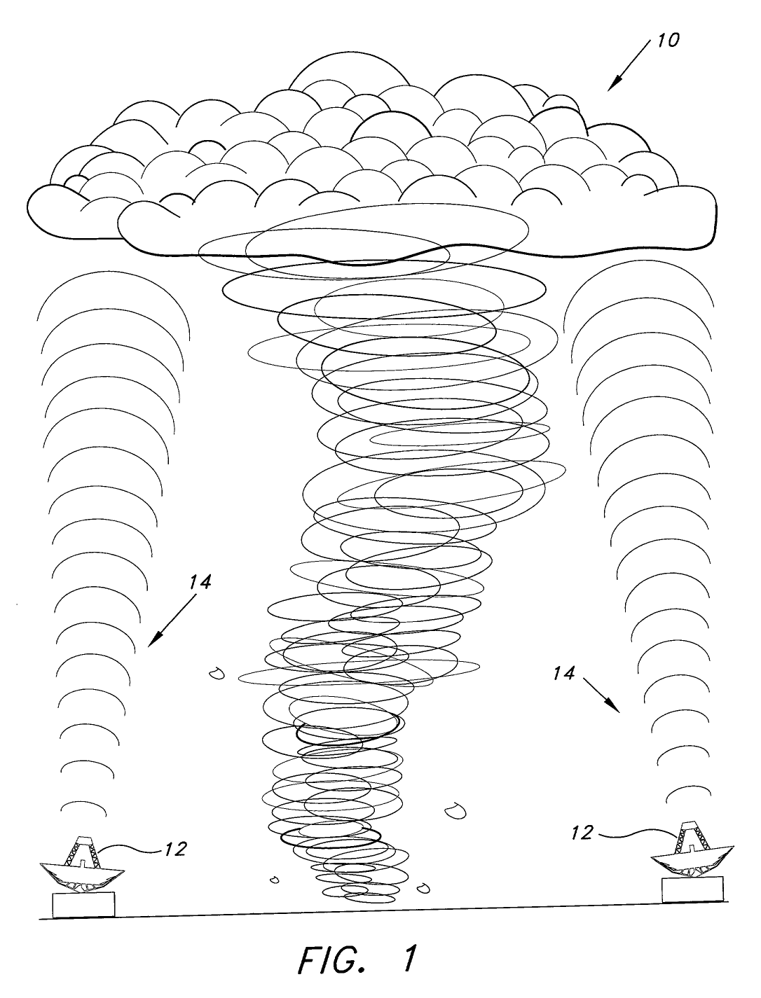

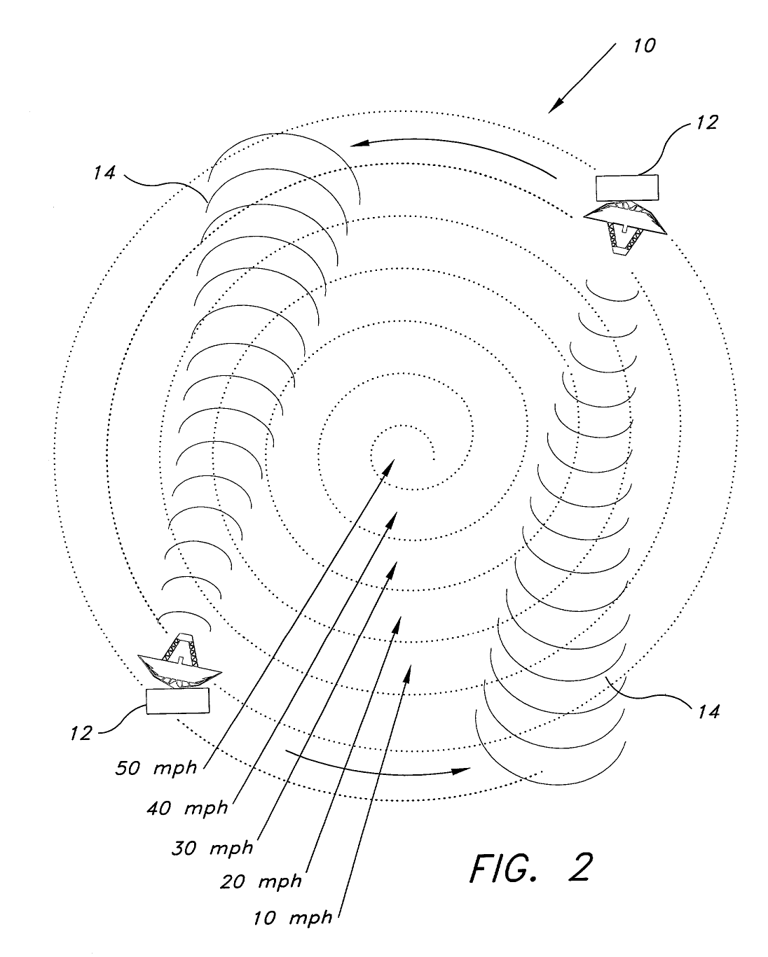

Referring to FIGS. 1 and 2, the present invention employs at least two high decibel audio generators 12 positioned to focus and project sound waves 14 at a weather system generally designated at 10. Weather system 10 comprises low atmosphere clouds and rotating winds having the potential to develop into a full fledged hurricane or tornado. Audio generators 12 are designed to produce sound waves 14 in the 100-2000 Hz frequency range. Generators 12 are not part of the inventive concept per se. For maximum effectiveness, the sound waves should be focused and projected toward a peripheral area of the rotating weather system and countercurrent to the rotating direction. As best seen in FIG. 2, generators 12 are disposed to direct the sound waves 14 in an area where the rotating velocity is approximately ten mph. When employed on a ship at sea, it may be necessary to utilize gyroscopes as mounts to ensure steady focus and projection of the generators.

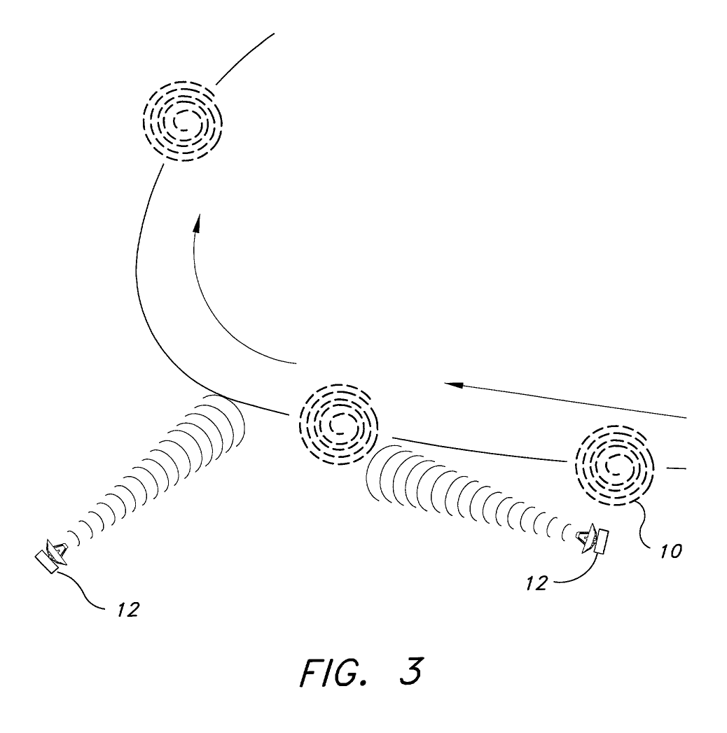

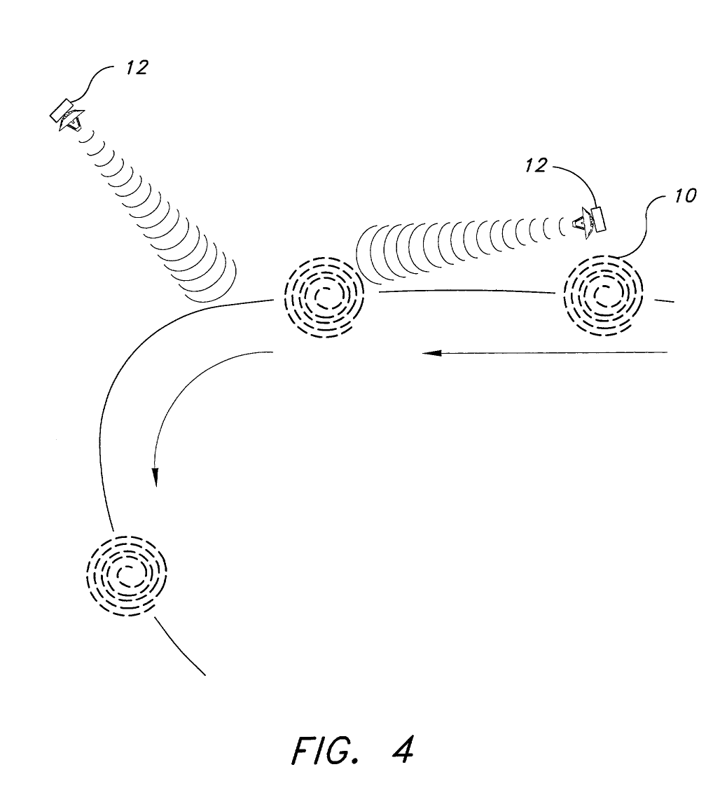

Since hurricanes and tornadoes contain large amounts of moisture, it may be desirable to direct these systems to areas in need of rain before disruption. FIGS. 3 and 4 schematically illustrate how generators 12 may focus sound waves 14 to direct the path of the weather systems. FIG. 3 illustrates how the sound waves are focused to guide a weather system 10 so that the system makes a turn to the right. FIG. 4 illustrates how the weather system may be turned to the left.

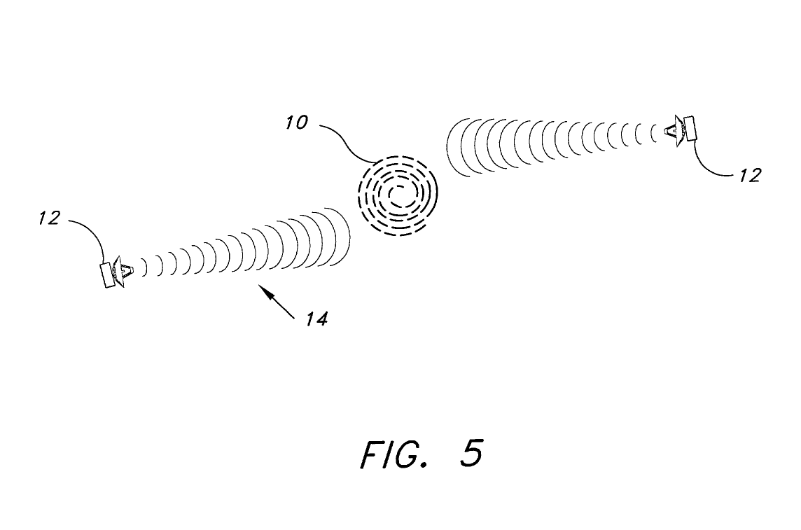

Under certain conditions, a nation might find it advantageous to create a tornado or hurricane. For example, creation of a strong storm system could deter an enemy attack. FIG. 5 illustrates generators 12 positioned to project sound waves concurrent with the rotational direction of winds to reinforce the rotating vector of weather system 10, thereby assisting the system in attaining hurricane or tornado status.

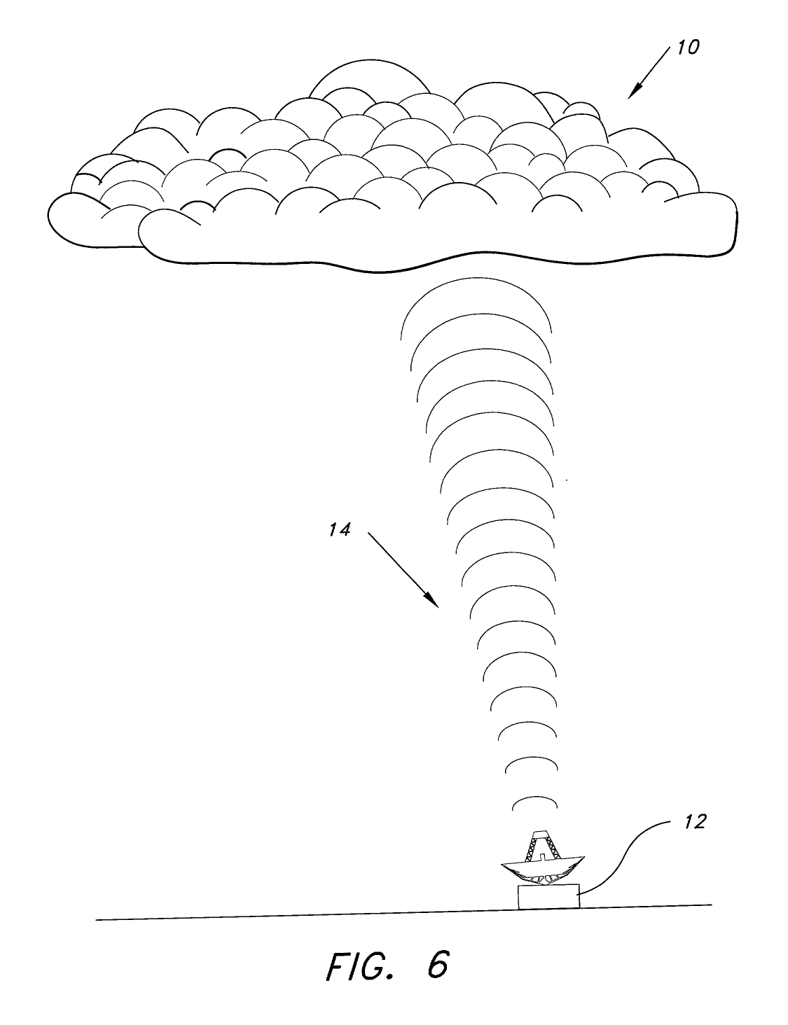

As illustrated in FIG. 6, a generator 12 projects waves 14 at a low atmospheric system 10 to produce rain. The contemplated projected frequency range is one thousand to two thousand fps. The sound waves are projected at an angle which would induce a rotational vector in the system having a partial rotational waddle of about five hundred to two thousand fpm.

It is to be understood that the present invention is not limited to the sole embodiments described above, but encompasses any and all embodiments within the scope of the following claims.

I claim:

1. A method of affecting the formation and direction of a weather system comprising:
locating a low atmospheric weather system having the potential to develop into a storm, said weather system having winds rotating in an observed direction; and
projecting high decibel sound waves toward a peripheral area of said weather system, whereby to affect the formation and direction of said weather system.

2. A method according to claim 1 wherein the winds of said weather system rotate at a higher velocity in a central area of said system and at a lower velocity at said peripheral area of said system and said sound waves are projected at said peripheral area where said winds have a velocity of about ten mph.

3. A method according to claim 2, wherein said sound waves are projected at a frequency range of 100-2000 Hz.

4. A method according to claim 3, wherein said weather system has the potential to develop into a destructive storm and said high decibel sound waves are projected countercurrent to said observed direction whereby to disrupt the formation of said weather system.

5. A method according to claim 4, wherein said destructive storm is a hurricane.

6. A method according to claim 4, wherein said destructive storm is a tornado.

7. A method according to claim 3, wherein said weather system has the potential to develop into a destructive storm and said high decibel sound waves are projected concurrently to said observed direction whereby to enhance the formation of said weather system.

8. A method according to claim 7, wherein said destructive storm is a hurricane.

9. A method according to claim 7, wherein said destructive storm is a tornado.

10. A method of affecting the formation a weather system comprising:
locating a low atmospheric weather system having the potential to produce rain; and
projecting high decibel sound waves toward said weather system, whereby to cause rain to emanate from said weather system.

11. A method according to claim 10, including the step of projecting said sound waves at a frequency range of between one thousand to thousand fps.

12. A method according to claim 11, including the step of projecting said sound waves at an angle which would induce a rotational vector in the system having a partial rotational waddle of about five hundred to two thousand fpm.
